(19) United States
(12) Patent Application Publication
(10) Pub. No.: US 2007/0195052 A1
(43) Pub. Date: Aug. 23, 2007

(54) Source driving apparatus, method of driving the same, display device having the same and method of driving the same

(75) Inventors: Se-Chun Oh, Gyeonggi-do (KR); Jong-Kun Yoo, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/580,396

(22) Filed: Oct. 12, 2006

(30) Foreign Application Priority Data
Feb. 21, 2006 (KR) 2006-16587

(51) Int. Cl. G09G 3/36

(52) U.S. Cl. 345/100

(57) ABSTRACT

A source driving apparatus includes a latch, an additional-data generator, an output controller and a buffer. The latch latches a normal-data signal received and outputs the latched normal-data signal. The additional-data generator generates an additional-data signal having a low value on the gray-scale and outputs the additional-data signal. The output controller controls the additional-data generator to output the generated additional-data signal during an invalid data interval of a predetermined frame. The buffer buffers the normal-data signal and the additional-data signal and outputs the normal-data signal and the additional-data signal. Therefore, instantaneous afterimage phenomenon may be eliminated by changing the structure of the source driver.

### CROSS-REFERENCE TO RELATED APPLICATIONS

This application relies for priority upon Korean Patent Application No. 2006-16587 filed on Feb. 21, 2006, the contents of which are herein incorporated by reference.

1. Field of the Invention

The present invention relates to a source driving apparatus for a display device and, more particularly, to a source driving apparatus for eliminating afterimages.

2. Description of the Related Art

Generally, an LCD apparatus displays an image by a hold-type image displaying method which tends to cause an instantaneous afterimage that is particularly noticeable when a fast moving image such as a movie. The instantaneous afterimage occurs when, after a black image is displayed on the entire LCD panel, a black image remains on the LCD panel although a subsequent white image is displayed.

### SUMMARY OF THE INVENTION

The present invention provides a source driving apparatus capable of eliminating an instantaneous afterimage by employing a source driving apparatus that includes a latch, an additional-data generator, an output controller and a buffer. The latch latches a normal-data signal received and outputs the latched normal-data signal. The additional-data generator generates an additional-data signal having a low value on the gray-scale and outputs the additional-data signal during an interval that is not valid for image data in a predetermined frame.

According to the present invention, a normal-data signal corresponding to K frames supplied by an external device is converted into an analog-type normal-data signal and is output during a valid data interval of the frames, wherein K is a natural number. An additional-data signal having a low value on the gray-scale is generated an output during an invalid data interval of the frame.

In an exemplary display device according to the present invention, a controller receives a primary data signal and a primary control signal from an external device. A source driver outputs a normal-data signal to the source lines during a valid data interval of a frame. The source driver generates an additional-data signal having a low value on the gray-scale and outputs the additional-data signal during an invalid data interval of a predetermined frame.

According to the present invention, instantaneous afterimage phenomenon is eliminated by changing the structure of the source driving apparatus.

### BRIEF DESCRIPTION OF THE DRAWING

The foregoing and other objects, features and advantages of the present invention will become more apparent from a reading of the following description together with the drawing, in which:

FIG. 1 is a plan view illustrating a display device in accordance with an example embodiment of the present invention;

FIG. 2 is a block diagram illustrating a driving chip in FIG. 1;

FIG. 3 is a block diagram illustrating a source driver in accordance with an example embodiment of the present invention in FIG. 2;

FIG. 4 is a timing chart illustrating a method of driving the source driver in FIG. 3;

FIG. 5 is a block diagram illustrating a source driver in accordance with another example embodiment of the present invention; and

FIG. 6 is a timing chart illustrating a method of driving the display device in FIG. 1.

### DESCRIPTION

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

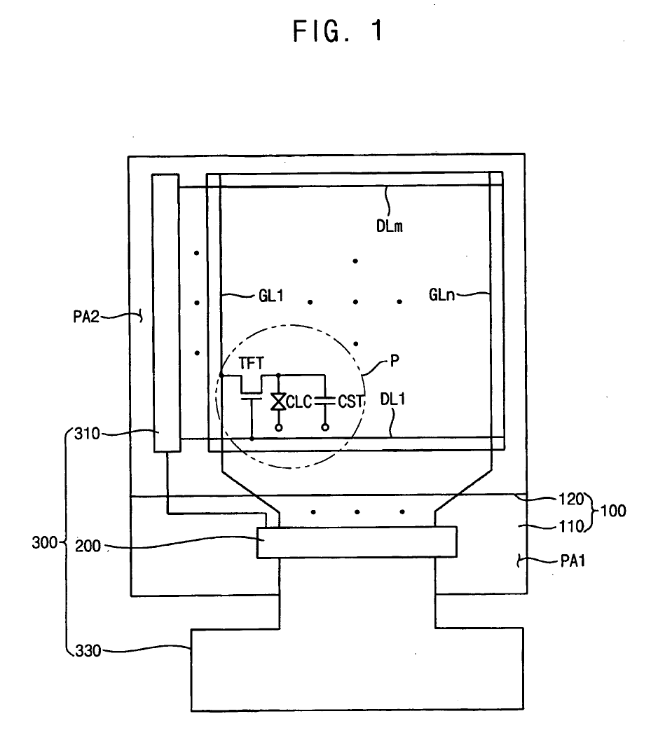

FIG. 1 is a plan view illustrating a display device in accordance with an example embodiment of the present invention.

Referring to FIG. 1, the display device includes a display panel 100 and a driving circuitry 300 for driving display panel 100. Display panel 100 includes a first substrate 110, a second substrate 120 facing the first substrate 110 and a liquid crystal layer (not shown) interposed between the first and second substrates. Display panel 100 includes a display region DA for displaying an image, a first peripheral region PA1 and a second peripheral region PA2. The first and second peripheral regions PA1 and PA2 adjoin the display region DA. A plurality of source lines DL1 . . . DLm and a plurality of gate lines GL1 . . . GLn crossing the source lines DL1 . . . DLm are formed in the display region DA, and a plurality of pixel areas is defined by the source and gate lines DL1, . . . DLm, GL1, . . . GLn. Each pixel area includes a switching device TFT electrically connected to one of the gate lines GL1 . . . GLn and one of the source lines DL1 . . . DLm, a liquid crystal capacitor CLC electrically connected to the switching device TFT, and a storage capacitor CST electrically connected to the liquid crystal capacitor CLC.

Driving circuitry 300 includes a driving chip 200, a gate driver 310 and a flexible printed circuit board 330. Driving chip 200 is mounted in the first peripheral region PA1 and controls gate driver 310. Driving chip 200 outputs a data signal to the source lines DL1 . . . DLm. The data signal includes a normal-data signal corresponding to a primary-data signal provided from an external device (not shown) and an additional-data signal of a low gray-scale for displaying an image of high quality. The additional-data signal of the low gray-scale is generated from driving circuitry 300. The additional-data signal of a low gray-scale may include data signals of a black gray-scale or a gray gray-scale.

Gate driver 310 is formed in the second peripheral region PA2 and outputs a gate signal activating the gate lines GL1 . . . GL1n so that the liquid crystal capacitor CLC is charged with the data signal. The flexible printed circuit board 330 is mounted on the first peripheral region PA1, and transmits the primary-data signal and a primary control signal that are provided from the external device, to driving chip 200.

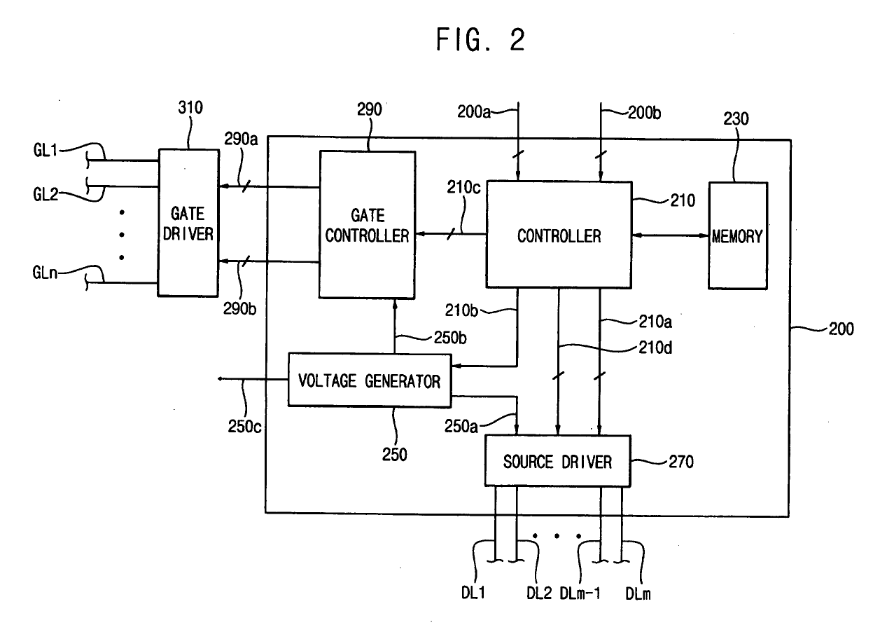

FIG. 2 is a block diagram illustrating a driving chip in FIG. 1.

Referring to FIGS. 1 and 2, driving circuitry 300 includes driving chip 200 and gate driver 310. Driving chip 200 includes a controller 210, a memory 230, a voltage generator 250, a source driver 270 and a gate controller 290.

Controller 210 receives the primary control signal 200a and the primary-data signal 200b. The primary control signal 200a includes a vertical synchronizing signal VSYNC, a horizontal synchronizing signal HSYNC, a main clock signal MCLK and a data enable signal DE. Controller 210 writes the primary-data signal 200b into memory 230 based on the primary control signal 200a. In addition, controller 210 reads the primary-data signal 200b from memory 230 based on the primary control signal 200a. Controller 210 outputs a first control signal 210a and the normal-data signal 210d that corresponds to the primary-data signal 200b read from memory 230, to source driver 270. Controller 210 outputs a second control signal 210b to voltage generator 250, and outputs a third control signal 210c to gate controller 290. The third control signal 210c includes a vertical start signal STV controlling gate driver 310, a first clock signal CK and a second clock signal CKB.

Memory 230 stores the primary-data signal 200a for a predetermined time interval such as a frame interval, a field interval, or a line interval.

Voltage generator 250 generates driving voltages based on the externally provided power source. The driving voltages include a gamma reference voltage VREF 250a, gate voltages VSS and VDD 250b and a common voltage VCOM 250c. The gamma reference voltage 250a is applied to source driver 270, and the gate voltages 250b are applied to gate controller 290. The common voltage 250c is applied to a common electrode of the liquid crystal capacitor CLC and the storage capacitor CST.

Source driver 270 changes the digital-type data signal into an analog-type data signal using the gamma reference voltage 250a based on the first control signal 210a. Then, source driver 270 outputs the analog-type data signal to the source lines DL1 . . . DLm.

The first control signal 210a includes the vertical and horizontal synchronizing signals VSYNC and HSYNC, a load signal TP and a reverse signal REV. Source driver 270 outputs a normal-data signal corresponding to each frame during a valid data interval of each frame of K frames based on the first control signal 210a. Also, source driver 270 outputs an additional-data signal of a low gray-scale between a last frame of the K frames and a next frame of the last frame. The additional-data signal is outputted during an invalid data interval of the frames. For example, the additional-data signal is outputted during a back-porch interval of the last frame and during a front-porch interval of the next frame.

Generally, a frame is divided into a front-porch interval, a valid data interval and a back-porch interval. The valid data interval is generally the interval in which an image is displayed on display panel 100. The front-porch and the back-porch intervals are generally not valid data intervals (hereinafter “invalid data” intervals), e.g., a blanking interval in which an image is not displayed.

For example, source driver 270 changes the normal-data signal being provided from controller 210 into a normal-data voltage, and outputs the normal-data voltage to the source lines DL1 . . . DLm during the valid data interval from a first frame to a 120-th frame. Then, source driver 270 applies a black data voltage to the source lines DL1 . . . DLm during a back-porch interval of the 120-th frame and during a front-porch interval of a 121-th frame. Generally, source driver 270 independently outputs the black data voltage every 120th or every 240th frame. Therefore, the circuit for decreasing the instantaneous afterimage phenomenon is simplified.

Gate controller 290 outputs the third control signal 210c and the gate voltage 250b to gate driver 310. Gate driver 310 is electrically coupled to source driver 270 and is operated based on the third control signal 210a. Particularly, when source driver 270 outputs the normal-data voltage during the valid data interval, gate driver 310 outputs the gate signal activating the gate lines GL1 . . . GLn during the valid data interval. When source driver 270 outputs the additional-data voltage during an invalid data interval, gate driver 310 outputs the gate signal activating the gate lines GL1 . . . GLn during the invalid data interval.

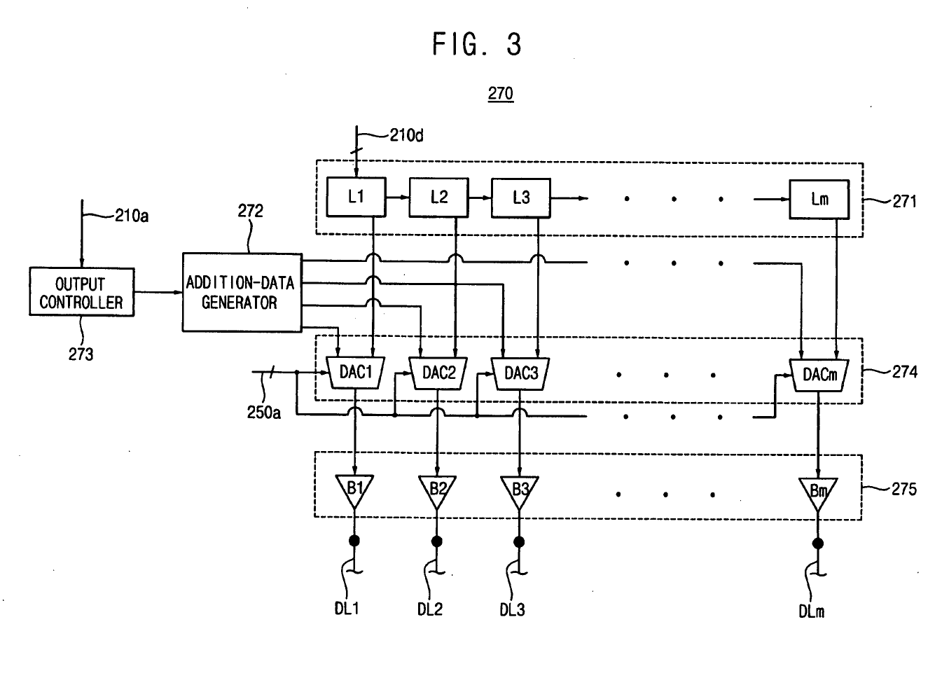

FIG. 3 is a block diagram illustrating a source driver in accordance with an example embodiment of the present invention in FIG. 2.

Referring to FIGS. 2 and 3, the source driver includes a latch 271, an additional-data generator 272, an output controller 273, a digital-analog converter 274 and a buffer 275.

Latch 271 latches a normal-data signal outputted from controller 210 by a line-unit. Latch 271 outputs to digital-analog converter 274 the normal-data signal that is latched by a line-unit based on the load signal that is the first control signal 210a.

Output controller 273 controls the additional-data generator 272 so that the additional-data generator 272 generates an additional-data signal of a low gray-scale, and outputs the additional-data signal of the low gray-scale to digital-analog converter 274. The additional-data signal may include digital signal. Particularly, output controller 273 counts the vertical synchronizing signal VSYNC and the horizontal synchronizing signal HSYNC that is the first control signal 210a, and declares an invalid data interval for a predetermined frame. Thereby, output controller 273 controls the additional-data generator to output the additional-data signal to digital-analog converter 274 during the invalid data interval of the predetermined frame.

Digital-analog converter 274 changes the normal-data signal and the additional-data signal that are output from latch 271 and additional-data generator 272, respectively, into analog-type data voltages using the gamma reference voltage 250a. Then, digital-analog converter 274 outputs the analog-type data voltages to buffer 275.

Buffer 275 buffers the normal-data signals and the additional-data signals, and outputs the normal-data signals and the additional-data signals to the source lines DL1 . . . DLm.

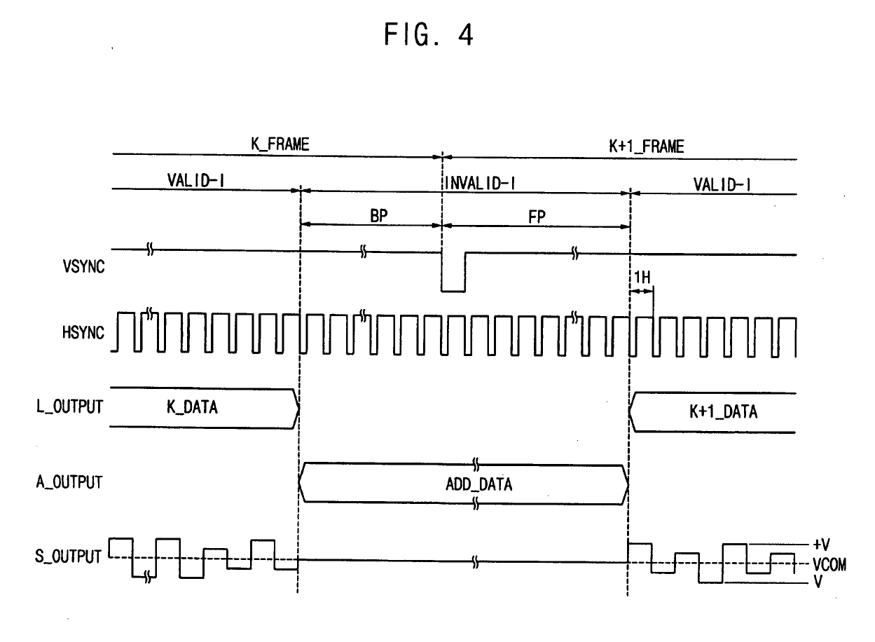

FIG. 4 is a timing chart illustrating a method of driving the source driver in FIG. 3.

Referring to FIGS. 3 and 4, source driver 270 outputs a normal-data voltage corresponding to each frame during a valid data interval VALID-I of each frame based on the first control signal 210a during K frames. Also, source driver 270 outputs an additional-data voltage during an invalid data interval INVALID-I of a last frame of K frames (hereinafter, referred to as K-th frame) and a next frame of the K-th frame (hereinafter, referred to as (K+1)-th frame).

Particularly, latch 271 outputs a normal-data signal K_DATA that is latched based on the load signal TP to digital-analog converter 274 during the valid data interval VALID_I of the K-th frame K_FRAME L_OUTPUT. Digital-analog converter 274 changes the normal-data signal K_DATA into an analog-type normal-data voltage, and outputs the analog-type normal-data voltage to buffer 275. Buffer 275 buffers the normal-data voltage, and outputs the normal-data voltage to the source lines DL1 . . . DLm S_OUTPUT.

Output controller 273 controls the additional-data generator 274 based on a vertical synchronizing signal VSYNC and a horizontal synchronizing signal HSYNC. Thereby, the additional-data generator 272 outputs the additional-data signal ADD_DATA to digital-analog converter 274 during the invalid data interval of the K-th frame and during the invalid data interval of the K+1-th frame A_OUTPUT. The invalid data interval of the K-th frame may include a back-porch interval BP, and the invalid data interval of the K+1-th frame may include a front-porch interval EP.

Digital-analog converter 274 changes the additional-data signal ADD_DATA into the analog-type additional-data voltage, and outputs the analog-type additional-data voltage to buffer 275. Buffer 275 buffers the additional-data voltage, and outputs the analog-type additional-data voltage to the source lines DL1 . . . DLm. A level of the additional-data voltage is changed according to the driving mode of the display panel. For example, when the display panel drives in a normally black mode, the level of the additional-data voltage may be substantially same as a level of the common voltage VCOM.

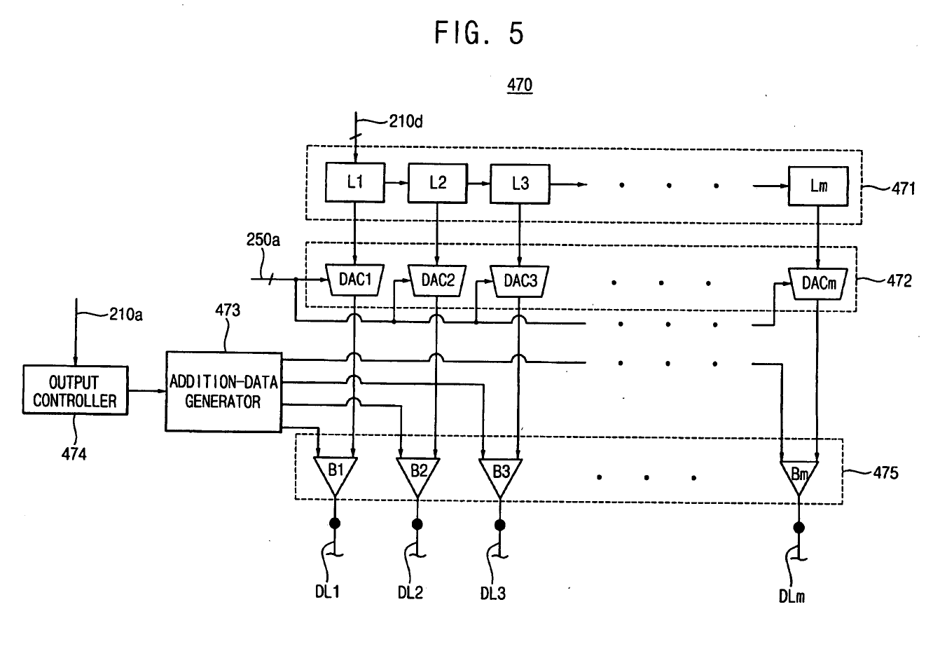

FIG. 5 is a block diagram illustrating a source driver in accordance with another example embodiment of the present invention.

Referring to FIGS. 3 and 5, the source driver 470 includes a latch 471, a digital-analog converter 472, an additional-data generator 473, an output controller 474 and a buffer 475. The source driver 470 may be substantially same as source driver 270 in accordance with an example embodiment of the present invention. However, an output signal of the additional-data generator 473 is input to the buffer 475. Therefore, the additional-data generator 473 outputs an analog-type additional-data voltage.

Output controller 474 controls the additional-data generator 473 so that the additional-data generator 473 outputs the additional-data voltage to the buffer 475 during an invalid data interval of a predetermined frame. The buffer 475 outputs the additional-data voltage to the source lines DL1 . . . DLm.

Hereinafter, since the structure and operation of the source driver 470 are the same as source driver 270 mentioned above, any further explanations will be omitted.

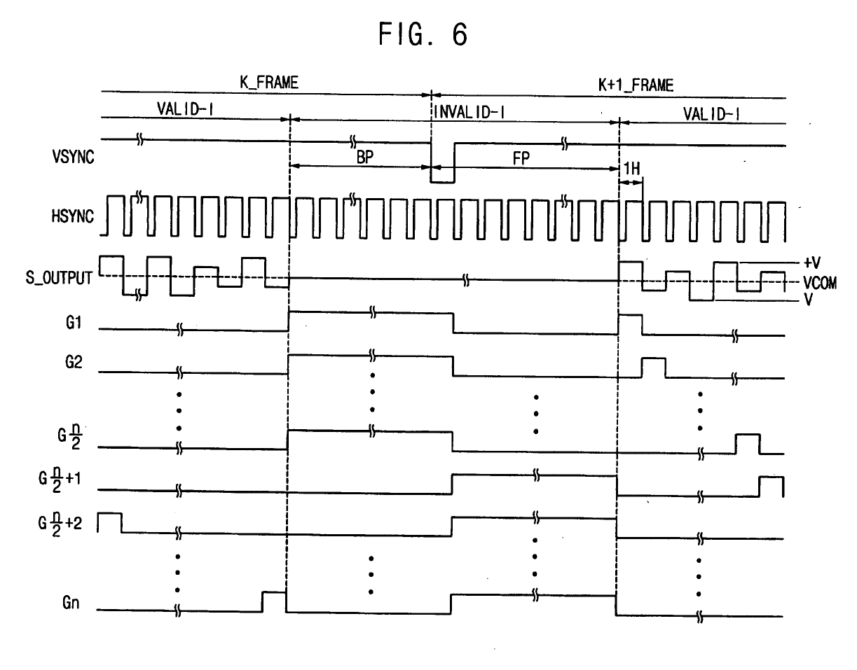

FIG. 6 is a timing chart illustrating a method of driving the display device in FIG. 1.

Referring to FIGS. 2 and 6, source driver 270 outputs a normal-data voltage corresponding to each frame during a valid data interval VALID-I of each frame based on the first control signal 210a. Source driver 270 outputs an additional-data voltage during an invalid data interval INVALID-I of a K-th frame that is a last frame of K frames and the K+1-th frame.

Firstly, source driver 270 changes a normal-data signal 210d that is provided from controller 210 into an analog-type normal-data voltage, and outputs the analog-type normal-data voltage to the source lines DL1 . . . DLm during the valid data interval VALID-I of the K-th frame K_FRAME. Then, controller 210 controls gate driver 310 so that gate driver 310 activates subsequently the gate lines GL1 . . . GLm during the valid data interval VALID-I. Preferably, each gate line GL1 is activated during 1 H interval. Hereby, K normal frame-images are displayed on a display panel (not shown).

Output controller 273 controls the additional-data generator 274 based on a vertical synchronizing signal VSYNC and a horizontal synchronizing signal HSYNC. The additional-data generator 272 outputs the additional-data signal during the invalid data interval of the K-th frame and during the invalid data interval of the K+1-th frame. The invalid data interval of the K-th frame may include a back-porch interval BP, and the invalid data interval of the K+1-th frame may include a front-porch interval EP. Thereby, source driver 270 outputs an additional-data voltage that corresponds to the additional-data signal to the source lines DL1 . . . DLm during the invalid data interval INVALID-I.

Then, controller 210 controls gate driver 310 so that gate driver 310 activates the gate lines GL1 . . . GLn during the invalid data interval INVALID-I. Hereby, after K normal frame-images are displayed, an addition frame-image of a low gray-scale is displayed on the display panel (not shown).

Gate lines GL1 . . . GLn may be activated in various methods during the invalid data interval INVALID-I. As shown in FIG. 6, gate driver 310 activates gate lines GL1 . . . GLn/2 from a first gate line to an n/2-th gate line during an early interval of the invalid data interval INVALID-I. Gate driver 310 activates gate lines GLn/2+1 . . . GLn from an n/2+1-th gate line to an n-th gate line during a latter interval of the invalid data interval INVALID-I. Preferably, the gate signals output during the invalid data interval INVALID-I may have a pulse-width substantially equal to or more than 1 H.

Alternately, gate driver 310 simultaneously activates the whole gate lines during the invalid data interval INVALID-I. The invalid data interval INVALID-I is divided into N intervals, and the gate lines are grouped into N groups. Gate driver 310 activates the gate lines of each group during each interval. Accordingly, gate driver 310 may activate the gate lines GL1 . . . GLn by various methods during the invalid data interval INVALID-I.

Then, source driver 270 outputs the normal-data voltage to source lines DL1 . . . DLm during the valid data interval VALID-I of the K+1-th frame. Gate driver 310 activates gate lines GL1 . . . GLn, in sequence.

Consequently, an addition-image of the low gray-scale is displayed between the K normal frame-images at the display panel (not shown), thereby eliminating the instantaneous afterimage phenomenon.

According to the present invention, the source driver counts the frames and outputs an additional-data signal having a low value on the gray-scale of voltages during an invalid data interval of a predetermined frame. Accordingly, when the image and the movie in high-quality are displayed, the instantaneous afterimage phenomenon is eliminated. Furthermore, instantaneous afterimage phenomenon is eliminated by changing a structure of the source driving apparatus, thereby simplifying the structure of the display device.

This invention has been described with reference to the exemplary embodiments. It is evident, however, that many alternative modifications and variations will be apparent to those having skill in the art and may be made without, however, departing from the spirit and scope of the invention.

What is claimed is:

1. A source driving apparatus comprising:
a latch that latches a normal-data signal received and outputs the latched normal-data signal;
an additional-data generator that generates an additional-data signal having a low value on the gray-scale and outputs the additional-data signal;
an output controller that controls the additional-data generator to output the generated additional-data signal during an invalid data interval of a predetermined frame; and
a buffer that buffers the normal-data signal and the additional-data signal and outputs the normal-data signal and the additional-data signal.

2. The source driving apparatus of claim 1, further comprising a digital-analog converter that converts the normal-data signal and the additional-data signal into an analog-type signal and outputs the analog-type signal to the buffer.

3. The source driving apparatus of claim 1, wherein the output controller determines the invalid data interval of the predetermined frame based on a synchronizing signal provided from an external device.

4. The source driving apparatus of claim 1, wherein the additional-data signal comprises a data signal of a black gray-scale.

5. A method of driving a source driving apparatus comprising:
converting a normal-data signal corresponding to K frames into an analog-type normal-data signal to output the normal-data signal in a valid data interval of the frames, wherein K is a natural number;
generating an additional-data signal having a low value on the gray-scale; and
outputting the additional-data signal during an invalid data interval of the frames.

6. The method of claim 5, wherein the invalid data interval of the frames comprises a back-porch interval of a last frame of a group of frames and a front-porch interval of a next frame adjacent to the last frame.

7. The method of claim 5, further comprising converting the generated additional-data signal into an analog-type additional-data signal.

8. A display device comprising:
a display panel having a plurality of source lines and a plurality of gate lines crossing the source lines and displaying a frame-image;
a controller receiving a primary data signal and a primary control signal from an external device;
a source driver outputting a normal-data signal corresponding to the primary data signal to the source lines during a valid data interval of a frame, the source driver generating an additional-data signal which has a low value on the gray-scale and outputting the additional-data signal of the low gray-scale during an invalid data interval of a predetermined frame; and
a gate driver being coupled with the source drivers and outputting a gate signal activating the gate lines.

9. The display device of claim 8, wherein the source driver comprises:
a latch that latches a normal-data signal received and outputs the normal-data signal;
an additional-data generator that generates an additional-data signal;
an output controller that controls the additional-data generator to output the generated additional-data signal during the invalid data interval of a predetermined frame; and
a buffer that buffers the normal-data signal and the additional-data signal and outputs that normal-data signal and the additional-data signal.

10. The display device of claim 9, wherein the output controller determines the invalid data interval of the predetermined frame based on the primary control signal.

11. The display device of claim 10, wherein the primary control signal comprises a vertical synchronizing signal and a horizontal synchronizing signal.

12. The display device of claim 8, wherein the source driver outputs the normal-signal signal corresponding to K frame-images and then outputs the additional-data signal.

13. The display device of claim 12, wherein the invalid data interval comprises a back-porch interval of a last frame of the frames and a front-porch interval of a next frame being adjacent to the last frame.

14. The display device of claim 8 wherein the gate driver outputs a gate signal that activates the gate lines and has a predetermined pulse-width during the invalid data interval.

15. The display device of claim 14, wherein the predetermined pulse-width comprises a pulse-width equal to or more than about 1 H.

16. A method of driving a display device comprising a display panel displaying a frame-image, comprising:
outputting a normal-data signal to the display panel during a valid data interval of each of K frames to display K normal frame-images; and
outputting an additional-data signal of a low gray-scale to the display panel during an invalid data interval adjacent to the valid data interval of a last frame of the K frames to display an addition frame-image.

17. The method of claim 16, wherein the invalid data interval of the frames comprises a back-porch interval of a last frame and a front-porch interval of a next frame being adjacent to the last frame.
